(19) United States
(12) Patent Application Publication
(10) Pub. No.: US 2026/0005255 A1
(43) Pub. Date: Jan. 1, 2026

(54) SOLID ELECTROLYTE, ELECTRODE MIXTURE, BATTERY, AND METHOD FOR PRODUCING BATTERY

(71) Applicant: TOYOTA JIDOSHA KABUSHIKI KAISHA, Toyota-shi (JP)

(72) Inventor: Toru KIDOSAKI, Miyoshi-shi (JP)

(73) Assignee: TOYOTA JIDOSHA KABUSHIKI KAISHA, Toyota-shi (JP)

(21) Appl. No.: 19/250,438

(22) Filed: Jun. 26, 2025

(30) Foreign Application Priority Data
Jul. 1, 2024 (JP) 2024-106088

(51) Int. Cl. H01M 4/62

(52) U.S. Cl. CPC H01M 4/628

(57) ABSTRACT

A main object of the present disclosure is to provide a solid electrolyte capable of suppressing the increase of battery resistance. The present disclosure achieves the object by providing a solid electrolyte, of which breaking energy when formed into a pellet having a length in X axis direction of 5 mm, a length in Y axis direction of 20 mm, and a length in Z axis direction of 1 mm, at a filling rate of 100% is 6.0*10³ kJ/m³ or more and 21.4*10³ kJ/m³ or less.

### TECHNICAL FIELD

The present disclosure relates to a solid electrolyte, an electrode mixture, a battery, and a method for producing a battery.

### BACKGROUND ART

A battery usually includes an anode current collector, an anode active material layer, an electrolyte layer, a cathode active material layer, and a cathode current collector. For example, Patent Literature 1 discloses that an all solid state lithium battery is produced using an anode slurry containing a silicon-based active material, a sulfide solid electrolyte, a styrene butadiene rubber, and a dispersion medium.

### CITATION LIST

### Patent Literature

Patent Literature 1: Japanese Patent Application Laid-Open (JP-A) No. 2019-125468

### SUMMARY OF DISCLOSURE

### Technical Problem

In a battery, an electrode active material layer may expand and contract due to charge and discharge, and when charge and discharge are repeated, there are risks that cracks may be generated in the electrode active material layer and the solid electrolyte layer, and peel-off of the electrode active material layer and the solid electrolyte layer may occur. When cracks are generated and peel-off occurs, the ion conduction path and the electron conduction path are cut out, and thus there is a risk of increasing the battery resistance. For this reason, from the view point of improving performance of a battery, it has been required to suppress the increase of the battery resistance by inhibiting the cracks and the peel-off.

The present disclosure has been made in view of the above circumstances and a main object thereof is to provide a solid electrolyte capable of suppressing the increase of battery resistance.

### Solution to Problem

[1]

A solid electrolyte, of which breaking energy when formed into a pellet having a length in X axis direction of 5 mm, a length in Y axis direction of 20 mm, and a length in Z axis direction of 1 mm, at a filling rate of 100% is 6.0*10³ kJ/m³ or more and 21.4*10³ kJ/m³ or less.

[2]

A solid electrolyte, of which breaking energy when formed into a pellet having a length in X axis direction of 5 mm, a length in Y axis direction of 20 mm, and a length in Z axis direction of 1 mm, at a filling rate of 100% is 6.0*10³ kJ/m³ or more;
the solid electrolyte used in an electrode mixture containing an electrode active material; and
a volume expansion rate of the electrode active material by charge and discharge is 4 times or less.
   [3]

The solid electrolyte according to [2], wherein the electrode active material is a cathode active material.

[4]

A solid electrolyte according to any one of [1] to [3], wherein the solid electrolyte is a sulfide solid electrolyte.

[5]

The solid electrolyte according to [4], wherein the sulfide solid electrolyte contains a Li element, an A element, which is at least one kind of P, As, Sb, Si, Ge, Sn, B, Al, Ga and In, and a S element.

[6]

The solid electrolyte according to [4] or [5], wherein the sulfide solid electrolyte contains a Li element, a P element, and a S element.

[7]

The solid electrolyte according to any one of [4] to [6], wherein the sulfide solid electrolyte contains a halogen element.

[8]

An electrode mixture comprising an electrode active material and a solid electrolyte, wherein
the solid electrolyte is the solid electrolyte according to any one of [1] to [7].
   [9]

A battery comprising a cathode active material layer, an anode active material layer, and an electrolyte layer arranged between the cathode active material layer and the anode active material layer, wherein
at least one of the cathode active material layer and the anode active material layer contains the electrode mixture according to [8].
   [10]

A battery comprising a cathode active material layer, an anode active material layer, and an electrolyte layer arranged between the cathode active material layer and the anode active material layer, wherein
the cathode active material layer contains a cathode active material of which volume expansion rate by charge and discharge is 4 times or less, and a first solid electrolyte,
the anode active material layer contains an anode active material of which volume expansion rate by charge and discharge is over 4 times, and a second solid electrolyte,
a breaking energy of the first solid electrolyte when formed into a pellet having a length in X axis direction of 5 mm, a length in Y axis direction of 20 mm, and a length in Z axis direction of 1 mm, at a filling rate of 100% is 6.0*10³ kJ/m³ or more, and
a breaking energy of the second solid electrolyte when formed into the pellet is larger than that of the first solid electrolyte.
   [11]

A method for producing a battery including a cathode active material layer, an anode active material layer, and an electrolyte layer arranged between the cathode active material layer and the anode active material layer, the method comprising:
a preparing step of preparing a layered body including the cathode active material layer, the anode active material layer, and the electrolyte layer, and
a densifying step of densifying the layered body by pressing, wherein
at least one of the cathode active material layer and the anode active material layer contains a solid electrolyte,
a breaking energy of the solid electrolyte when formed into a pellet having a length in X axis direction of 5 mm, a length in Y axis direction of 20 mm, and a length in Z axis direction of 1 mm, at a filling rate of 100% is 6.0*10³ kJ/m³ or more, and
in the densifying step, the pressing is performed at a temperature less than 135° C.

### Advantageous Effects of Disclosure

The present disclosure exhibits an effect of suppressing the increases of the battery resistance.

### BRIEF DESCRIPTION OF DRAWINGS

FIG. 1 is a schematic perspective view exemplifying pellet in the present disclosure.

FIG. 2 is a schematic cross-sectional view exemplifying the battery in the present disclosure.

FIG. 3 is a graph showing a relation between the breaking energy and the battery resistance in Examples, Comparative Examples, and Reference Examples.

### DESCRIPTION OF EMBODIMENTS

The solid electrolyte, the electrode mixture, the battery, and the method for producing the battery in the present disclosure will be hereinafter explained in details.

### A. Solid Electrolyte

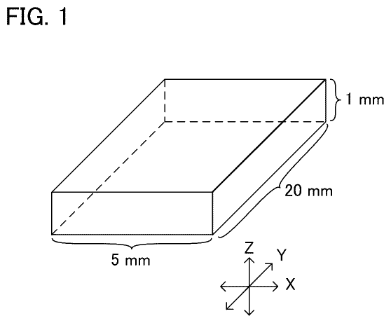

As shown in FIG. 1, a breaking energy of the solid electrolyte in the present disclosure when formed into a pellet having a length in X axis direction of 5 mm, a length in Y axis direction of 20 mm, and a length in Z axis direction of 1 mm, at a filling rate of 100% is 6.0*10³ kJ/m³ or more. As an example of the embodiment of the solid electrolyte in the present disclosure, the breaking energy of the solid electrolyte may be 21.4*10³ kJ/m³ or less. Also, as another example of the embodiment of the solid electrolyte in the present disclosure, the solid electrolyte may be used in an electrode mixture containing an electrode active material. Further, a volume expansion rate of the electrode active material by charge and discharge may be 4 times or less.

According to the present disclosure, when the breaking energy when formed into a pellet in the specified size is in the specified range, the close adhesion (bonding force) of the solid electrolyte is high, and thus it is considered that the generation of cracks in the electrode active material layer and the solid electrolyte layer, and the occurrence of the peel-off of the electrode active material layer and the solid electrolyte layer can be inhibited even when the electrode active material layer expands and contracts due to charge and discharge of the battery. As a result, favorable ion conduction path and electron conduction path can be maintained, and the increase of the battery resistance can be suppressed.

The breaking energy at the filling rate of 100% (filling rate of solid electrolyte in the pellet) may be 6.3*10³ kJ/m³ or more, may be 8.0*10³ kJ/m³ or more, and may be 10.0*10³ kJ/m³ or more. Meanwhile, the breaking energy is, for example, 75.0*10³ kJ/m³ or less, and may be 67.9*10³ kJ/m³ or less. Incidentally, the breaking energy may be less than 11.9*10³ kJ/m³. The breaking energy can be measured by the method described in Examples. Also, the breaking energy can be adjusted by, for example, the composition of the solid electrolyte, the crystallinity of the solid electrolyte, and the particle size of the solid electrolyte.

The crystallinity of the solid electrolyte is, for example, 80% or less, may be 70% or less, may be 60% or less, and may be 50% or less. The smaller the crystallinity of the solid electrolyte, the more the breaking energy tends to increase. Meanwhile, the crystallinity is, for example, 5% or more, may be 10% or more, and may be 30% or more. The crystallinity may be a value obtained by an X-ray diffraction method. Also, the crystallinity may be a value obtained by a differential scanning calorimetry (DSC).

The Li ion conductivity of the solid electrolyte is preferably high. The Li ion conductivity of the solid electrolyte at 25° C. is, for example, 1*10⁻⁴ S/cm or more, and preferably 1*10⁻³ S/cm or more. The insulation of the solid electrolyte is preferably high. The electron conductivity of the solid electrolyte at 25° C. is, for example, 10⁻⁶ S/cm or less, may be 10⁻⁸ S/cm or less, and may be 10⁻¹⁰ S/cm or less. Also, examples of the shape of the solid electrolyte may include a granular shape. The average particle size (D₅₀) of the solid electrolyte is, for example, 0.1 μm or more and 50 μm or less.

Incidentally, the average particle size (D₅₀) refers to 50% accumulation particle size in a volume-based particle distribution by a laser diffraction particle distribution measurement device.

Examples of the solid electrolyte may include an inorganic solid electrolyte such as a sulfide solid electrolyte, an oxide solid electrolyte, and a nitride solid electrolyte; and an organic solid electrolyte such as a polymer electrolyte. Among these, a sulfide solid electrolyte is preferable. The reason therefor is its high Li ion conductivity.

The sulfide solid electrolyte preferably contains sulfur (S) as a main component of the anion element. The oxide solid electrolyte preferably contains oxygen (O) as a main component of the anion element. The nitride solid electrolyte preferably contains nitrogen (N) as a main component of the anion element.

It is preferable that the sulfide solid electrolyte contains, for example, a Li element, an A element (A is at least one kind of P, As, Sb, Si, Ge, Sn, B, Al, Ga, and In), and a S element. Also, the sulfide solid electrolyte may further contain at least one of an O element and a halogen element. Examples of the halogen element may include a F element, a Cl element, a Br element, and an I element.

The sulfide solid electrolyte preferably includes an anion structure of an ortho composition (such as PS₄³⁻ structure, SiS₄⁴⁻ structure, GeS₄⁴⁻ structure, ALS₃³⁻ structure, or BS₃³⁻ structure) as the main component of the anion structure. The reason therefor is that chemical stability is high. The proportion of the anion structure of the ortho composition with respect to all the anion structures in the sulfide solid electrolyte is, for example, 70 molo or more and may be 90 mol % or more.

The sulfide solid electrolyte may include a crystal phase. Examples of the crystal phase may include a Thio-LISICON type crystal phase, a LGPS type crystal phase, and an argyrodite type crystal phase.

There are no particular limitations on the composition of the sulfide solid electrolyte, and examples thereof may include xLi₂S·(100−x) P₂S₅ (70≤x≤80), and yLiI·zLiBr·(100−y−z) (xLi₂S·(1−x) P₂S₅) (0.7≤x≤0.8, 0≤y≤30, 0≤z≤30).

The sulfide solid electrolyte may have a composition represented by a general formula: Li₄₋ₓGe₁₋ₓPₓS₄ (0<x<1). In the general formula, at least a part of Ge may be substituted with at least one of Sb, Si, Sn, B, Al, Ga, In, Ti, Zr, V and Nb. In the general formula, at least a part of P may be substituted with at least one of Sb, Si, Sn, B, Al, Ga, In, Ti, Zr, V and Nb. In the general formula, a part of Li may be substituted with at least one of Na, K, Mg, Ca and Zn. In the general formula, a part of S may be substituted with halogen (at least one of F, Cl, Br and I).

The sulfide solid electrolyte may have a composition represented by Li₇₋ₐPS₆₋ₐXₐ, wherein X is at least one kind of Cl, Br, and I, and “a” is a number of 0 or more and 2 or less. The “a” may be 0 and may be larger than 0. In the latter case, the “a” may be 0.1 or more, may be 0.5 or more, and may be 1 or more. Also, the “a” may be 1.8 or less, and may be 1.5 or less.

Examples of the oxide solid electrolyte may include a perovskite type solid electrolyte such as (Li, La)TiO₃. Examples of the nitride solid electrolyte may include Li₃N, and Li₃N—LiI—LiOH. Also, examples of the polymer electrolyte may include a polyethylene oxide (PEO), and a polypropylene oxide (PPO).

The solid electrolyte in the present disclosure may be used in an electrode mixture containing an electrode active material. The electrode active material may be a cathode active material and may be an anode active material. Details of the electrode mixture will be described in “B. Electrode mixture” later. Meanwhile, the solid electrolyte in the present disclosure may be used for an electrolyte layer of a battery. The electrolyte layer will be described in “C. Battery” later.”

### B. Electrode Mixture

The electrode mixture in the present disclosure contains an electrode active material and the above described solid electrolyte.

According to the present disclosure, the above described solid electrolyte is used, and thus an electrode mixture capable of suppressing the increase of the battery resistance may be achieved.

The volume expansion rate of the electrode active material by charge and discharge may be 4 times or less. For example, a volume expansion rate of an oxide active material (such as NCM and NCA) useful as a cathode active material is less than 1.1 times, and a volume expansion rate of graphite that is useful as an anode active material is about 1.1 times, and a volume expansion rate of silicon that is also useful as an anode active material is over 4 times. The expansion rate by charge and discharge can be obtained by space-group-independent evaluation, as described in “Simon Schweidler et al., “Volume Changes of Graphite Anodes Revisited: A Combined Operando X-ray Diffraction and In Situ Pressure Analysis Study”, J. Phys. Chem. C 2018, 122, 16, 8829-8835”. The expansion rate of the electrode active material by charge and discharge may be 3 times or less, may be 2 times or less, may be 1.5 times or less, and may be 1.2 times or less. Incidentally, the volume of the cathode active material usually contracts when charged, and expands when discharged. Meanwhile, the volume of the anode active material usually expands when charged, and contracts when discharged.

The electrode mixture in the present disclosure may be a cathode mixture containing a cathode active material as the electrode active material, and may be an anode mixture containing an anode active material as the electrode active material.

Examples of the cathode active material may include an oxide active material. Examples of the oxide active material may include a rock salt bed type active, a spinel type active material, and an olivine type active material. Examples of the rock salt bed type active material may include an active material containing a Li element, a Ni element, a Co element, a Mn element, and an O element (NCM-based active material). Examples of the NCM-based active material may include LiNi_{1/3}Co_{1/3}Mn_{1/3}O₂. Other examples of the rock salt bed type active material may include an active material containing a Li element, a Ni element, a Co element, an Al element, and an O element (NCA-based active material). Examples of the NCA-based active material may include LiNi_{0.8}Co_{0.15}Mn_{0.05}O₂. Examples of the spinel type active material may include LiMn₂O₄. Examples of the olivine type active material may include LiFePO₄. Also, as the cathode active material, sulfur(S) may be used.

Examples of the anode active material may include a Li-based active material such as a metal lithium and a lithium alloy; a carbon-based active material such as graphite, hard carbon and soft carbon; an oxide-based active material such as lithium titanate; and a Si-based active material.

Examples of the shape of the electrode active material may include a granular shape. The average particle size (D₅₀) of the electrode active material is, for example, 10 nm or more, and may be 100 nm or more. Meanwhile, the average particle size (D₅₀) of the electrode active material is, for example, 50 μm or less, and may be 20 μm or less.

The solid content ratio of the electrode active material in the electrode mixture is, for example, 50 volume % or more, may be 60 volumes or more and may be 70 volume % or more. Meanwhile, the solid content ratio of the electrode active material in the electrode mixture is, for example, 90 volumes or less.

The electrode mixture contains a solid electrolyte. The solid electrolyte is as described in “A. Solid electrolyte”. The solid content ratio of the solid electrolyte in the electrode mixture is, for example, 20 volumes or more, may be 30 volumes or more, and may be 40 volume % or more. Meanwhile, the solid content ratio of the solid electrolyte in the electrode mixture is, for example, 50 volumes or less.

The electrode mixture may contain at least one of a conductive aid and a binder, as required. Examples of the conductive aid may include a carbon material. Examples of the carbon material may include a particulate carbon material such as acetylene black (AB) and Ketjen black (KB); and a fiber carbon material such as carbon fiber, carbon nanotube (CNT) and carbon nanofiber (CNF).

Examples of the binder may include a rubber-based binder such as butadiene rubber (BR), acrylate butadiene rubber (ABR), and styrene butadiene rubber (SBR); and a fluorine-containing binder such as polyvinylidene fluoride (PVDF) and polytetra fluoroethylene (PTFE).

The electrode mixture may contain an electrolyte solution (liquid electrolyte) as the electrolyte. When the electrode mixture contains a liquid electrolyte, the rate of the liquid electrolyte with respect to whole electrolyte is, for example, 10 mass % or less. Examples of the liquid electrolyte may include conventionally known liquid electrolytes that can be used in a lithium ion battery.

### C. Battery

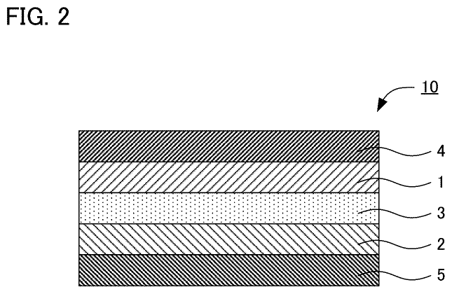

FIG. 2 is a schematic cross-sectional view exemplifying the battery in the present disclosure. Battery 10 shown in FIG. 2 includes cathode active material layer 1, anode active material layer 2, and electrolyte layer 3 arranged between the cathode active material layer 1 and the anode active material layer 2. At least one of the cathode active material layer 1 and the anode active material layer 2 contains the above described electrode mixture. Also, as shown in FIG. 2, the battery 10 usually includes cathode current collector 4 for collecting electrons of the cathode active material layer 1, and anode current collector 5 for collecting electrons of the anode active material layer 2.

According to the present disclosure, by using the above described electrode mixture, a battery capable of suppressing the increase of resistance may be achieved.

### 1. Cathode Active Material Layer

The cathode active material layer contains at least a cathode active material. The cathode active material layer may contain at least one of a conductive aid, a binder, and an electrolyte, as required. Above all, it is preferable that the cathode active material layer contains the electrode mixture described in “B. Electrode mixture” above. Also, the thickness of the cathode active material layer is not particularly limited, but for example, it is 0.1 μm or more and 1000 μm or less.

### 2. Anode Active Material Layer

The anode active material layer contains at least an anode active material. The anode active material layer may contain at least one of a conductive aid, a binder, and an electrolyte, as required. Above all, it is preferable that the anode active material layer contains the electrode mixture described in “B. Electrode mixture” above. Also, the thickness of the anode active material layer is not particularly limited, but for example, it is 0.1 μm or more and 1000 μm or less.

### 3. Electrolyte Layer

The electrolyte layer contains at least an electrolyte. The electrolyte layer may contain a solid electrolyte as the electrolyte. There are no particular limitations on the kind of the solid electrolyte, and for example, the solid electrolyte described in “A. Solid electrolyte” above may be used. The electrolyte layer may contain a binder as required. The binder is as described above. Meanwhile, the electrolyte layer may contain an electrolyte solution (liquid electrolyte) as the electrolyte. Also, the electrolyte layer may contain, as the electrolyte, just the solid electrolyte, may contain both the solid electrolyte and the electrolyte solution, and may contain just the electrolyte solution. Also, the thickness of the electrolyte layer is not particularly limited, but for example, it is 0.1 μm or more and 1000 μm or less.

Also, the present disclosure can also provide a battery including a cathode active material layer, an anode active material layer, and an electrolyte layer arranged between the cathode active material layer and the anode active material layer, wherein the electrolyte layer contains the solid electrolyte described in “A. Solid electrolyte” above.

### 4. Cathode Current Collector and Anode Current Collector

Examples of the material for the cathode current collector may include a metal such as aluminum, SUS, and nickel. Examples of the material for the anode current collector may include a metal such as copper, SUS, and nickel. Examples of the shape of the cathode current collector and the anode current collector may include a foil shape and a mesh shape.

### 5. Battery

The battery in the present disclosure may include an outer package for storing the above described members. Examples of the outer package may include a laminate type outer package and a case type outer package. Also, the battery in the present disclosure may include a restraining jig that applies a restraining pressure of a thickness direction to the above described members. As the restraining jig, known jigs may be used. The restraining pressure is, for example, 0.1 MPa or more and 50 MPa or less, and may be 1 MPa or more and 20 MPa or less.

The kind of the battery in the present disclosure is not particularly limited, but is typically a lithium ion secondary battery. The application of the battery is not particularly limited, and examples thereof may include a power source for vehicles such as hybrid electric vehicles (HEV), plug-in hybrid electric vehicles (PHEV), battery electric vehicles (BEV), gasoline-fueled automobiles and diesel powered automobiles. In particular, it is preferably used as a power source for driving hybrid electric vehicles (HEV), plug-in hybrid electric vehicles (PHEV), and battery electric vehicles (BEV). Also, the battery in the present disclosure may be used as a power source for moving bodies other than vehicles (such as rail road transportation, vessel and airplane), and may be used as a power source for electronic products such as information processing equipment.

The present disclosure can also provide a battery including a cathode active material layer, an anode active material layer, and an electrolyte layer arranged between the cathode active material layer and the anode active material layer, wherein the cathode active material layer contains a cathode active material of which volume expansion rate by charge and discharge is 4 times or less, and a first solid electrolyte; the anode active material layer contains an anode active material of which volume expansion rate by charge and discharge is over 4 times, and a second solid electrolyte; a breaking energy of the first solid electrolyte when formed into a pellet having a length in X axis direction of 5 mm, a length in Y axis direction of 20 mm, and a length in Z axis direction of 1 mm, at a filling rate of 100% is 6.0*10³ kJ/m³ or more; and a breaking energy of the second solid electrolyte when formed into the pellet is larger than that of the first solid electrolyte.

Details of the first solid electrolyte and the second solid electrolyte are in the same contents as those described in “A. Solid electrolyte” above. The ratio of the breaking energy of the second solid electrolyte with respect to the breaking energy of the first solid electrolyte is, for example, 1.2 times or more, may be 1.5 times or more, may be 2.0 times or more, and may be 3.0 times or more. Also, the breaking energy of the second solid electrolyte may be 34.2*10³ kJ/m³ or more, and may be 51.3*10³ kJ/m³ or more.

### D. Method for Producing Battery

The method for producing a battery in the present disclosure is a method for producing a battery including a cathode active material layer, an anode active material layer, and an electrolyte layer arranged between the cathode active material layer and the anode active material layer, the method including: a preparing step of preparing a layered body including the cathode active material layer, the anode active material layer, and the electrolyte layer, and a densifying step of densifying the layered body by pressing. Also, at least one of the cathode active material layer and the anode active material layer contains a solid electrolyte, and a breaking energy of the solid electrolyte when formed into a pellet having a length in X axis direction of 5 mm, a length in Y axis direction of 20 mm, and a length in Z axis direction of 1 mm, at a filling rate of 100% is 6.0*10³ kJ/m³ or more. Also, in the densifying step, the pressing is performed at a temperature less than 135° C.

According to the present disclosure, by using the above described solid electrolyte, a battery capable of suppressing the increase of resistance can be obtained even when densified at a low temperature.

### 1. Preparing Step

The preparing step in the present disclosure is a step of preparing a layered body including the cathode active material layer, the anode active material layer, and the electrolyte layer.

At least one of the cathode active material layer and the anode active material layer contains a solid electrolyte. A breaking energy of the solid electrolyte when formed into a pellet having a length in X axis direction of 5 mm, a length in Y axis direction of 20 mm, and a length in Z axis direction of 1 mm, at a filling rate of 100% is 6.0*10³ kJ/m³ or more. Also, the details of the solid electrolyte are in the same contents as those described in “A. Solid electrolyte”.

There are no particular limitations on a method for preparing the layered body, but examples thereof may include a method in which a cathode including a cathode current collector and a cathode active material layer, an anode including an anode current collector and anode active material layer, and an electrolyte layer containing a solid electrolyte are prepared, and the electrolyte layer is arranged between the cathode and the anode. Examples of the method for producing the cathode may include a method in which a cathode mixture containing a dispersion medium is applied on the cathode current collector and dried. Examples of the method for producing the anode may include a method in which an anode mixture containing a dispersion medium is applied on the anode current collector and dried. Examples of the method for producing the electrolyte layer may include a method in which a mixture for electrolyte layer containing a dispersion medium is applied on a substrate and dried.

### 2. Densifying Step

The densifying step in the present disclosure is a step of densifying the layered body by pressing. Also, in the densifying step, the pressing is performed at a temperature less than 135° C.

The temperature at the time of pressing may be 130° C. or less, may be 110° C. or less, may be 100° C. or less, may be 50° C. or less, and may be 40° C. or less. Also, the pressing may be performed at a room temperature without heating at the time of pressing. Meanwhile, there are no particular limitations on the method for heating when heating is performed at the time of pressing, but examples thereof may include a method for heating a pressing machine.

Examples of the pressing method may include a roll pressing and a flat plate pressing. There are no particular limitations on a pressure at the time of pressing, but when a linear pressure is applied, for example, it is 1.0 ton/cm or more and 10.0 ton/cm or less, and may be 1.5 ton/cm or more and 6.0 ton/cm or less. Also, when a surface pressure is applied, the pressure at the time of pressing is, for example, 800 MPa or more and 2000 MPa or less.

### 3. Battery

The battery is in the same contents as those described in “C. Battery”. The present disclosure can also provide a method for producing a battery including a cathode active material layer, an anode active material layer, and an electrolyte layer arranged between the cathode active material layer and the anode active material layer, the method including: a preparing step of preparing a layered body including the cathode active material layer, the anode active material layer, and the electrolyte layer; and a densifying step of densifying the layered body by pressing, wherein the electrolyte layer contains a solid electrolyte, a breaking energy of the solid electrolyte when formed into a pellet having a length in X axis direction of 5 mm, a length in Y axis direction of 20 mm, and a length in Z axis direction of 1 mm, at a filling rate of 100% is 6.0*10³ kJ/m³ or more, and in the densifying step, the pressing is performed at a temperature less than 135° C. The details of the solid electrolyte and the details of the pressing conditions are as described above.

Incidentally, the present disclosure is not limited to the embodiments. The embodiments are exemplification, and any other variations are intended to be included in the technical scope of the present disclosure if they have substantially the same constitution as the technical idea described in the claims of the present disclosure and have similar operation and effect thereto.

### EXAMPLES

### <Production of Sulfide Solid Electrolyte A>

A raw material composition was obtained by mixing Li₂S, P₂S₅, LiI and LiBr. This raw material composition and tetrahydrofuran 20 times of the raw material composition in the mass ratio were put in a container made of glass, and agitated at 25° C. for 72 hours. After that, a sediment was collected as a precursor of a sulfide solid electrolyte. The collected precursor was dried at 25° C. under an argon atmosphere, and then burned at 100° C. for 1 hour under an atmospheric pressure. The obtained burned body was vacuum-sealed in a quartz tube, the quartz tube was placed in a muffle furnace, and burned at 140° C. for 5 hours. Thereby, a sulfide solid electrolyte A (LiBr—LiI—Li₃PS₄-based sulfide solid electrolyte) was obtained.

### <Production of Sulfide Solid Electrolytes B to E>

Sulfide solid electrolytes B to E were respectively produced in the same manner as for the sulfide solid electrolyte A, except that the burning temperature in the muffle furnace was respectively changed as shown in Table 1.

### <Production of Sulfide Solid Electrolyte F>

A raw material composition was obtained by mixing Li₂S, P₂S₅, LiBr and LiCl. This raw material composition and tetrahydrofuran 20 times of the raw material composition in the mass ratio were put in a container made of glass, and agitated at 25° C. for 72 hours. After that, a sediment was collected as a precursor of a sulfide solid electrolyte. The collected precursor was dried at 25° C. under an argon atmosphere, and then burned at 100° C. for 1 hour under an atmospheric pressure. The obtained burned body was vacuum-sealed in a quartz tube, the quartz tube was placed in a muffle furnace, and burned at 550° C. for 5 hours. Thereby, a sulfide solid electrolyte F (sulfide solid electrolyte including an argyrodite type crystal phase) was obtained.

### <Production of Sulfide Solid Electrolyte G>

Sulfide solid electrolyte G was produced in the same manner as for the sulfide solid electrolyte F, except that the burning temperature in the muffle furnace was changed as shown in Table 1.

### [Measurement of Breaking Energy]

The breaking energy of the sulfide solid electrolytes A to G was respectively measured. In specific, 0.2 g of the sulfide solid electrolyte was respectively collected, pressed at pressures of 5 kN, 20 kN, and 35 kN using a pressing jig, and formed into a pellet as shown in FIG. 1. To the obtained three pellets, a bending test was performed using TENSIRON (from A&D Company, Limited). The condition for the bending test was 0.05 mm/min in a compression mode of TENSIRON. The breaking energy was calculated by integrating the stress/skew curve formed based on the stress (bending stress) and the warp (bending warp) obtained from the bending test. The results are shown in Table 1. The stress was calculated from the below formula (1), and the warp was calculated from the below formula (2).

$$[ Formula 1 ]$$

$$σ = \frac{3 FL}{2 {bh}^{2}} \qquad ( 1 )$$

In the formula (1), σ is the bending stress (MPa), b is the width of pellet (5 mm), h is the thickness of pellet (1 mm), F is the stress (N), and L is the distance between supporting points (18.5 mm).

$$[ Formula 2 ]$$

$${ε}_{i} = \frac{6 hs}{{L}^{2}} \qquad ( 2 )$$

In the formula (2), &i is the bending warp (%), h is the thickness of the pellet (1 mm), s is the flection (mm), and L is the distance between supporting points (18.5 mm).

Here, the breaking energy shown in Table 1 is the breaking energy of the pellet, of which filling rate of the sulfide solid electrolyte obtained based on the calibration curve was 100%. The calibration curve of the filling rate and the breaking energy was formed by producing the above described three pellets and performing the bending test to the three pellets.

TABLE 1

| | |
|---|---|
| SE | Bending test |

| | Burining | | | Breaking |
|---|---|---|---|---|
| | temper- | Breaking | Breaking | energy |
| | ature | stress | warp | (*10³kJ/ |
| Kind | (° C.) | (MPa) | (%) | m³) |
| A | 140 | 72 | 0.450 | 16.2 |
| B | 160 | 42 | 0.482 | 10.1 |
| C | 180 | 33 | 0.382 | 6.3 |
| D | 200 | 30 | 0.383 | 5.7 |
| E | 220 | 26 | 0.384 | 5.0 |
| F | 550 | 62 | 0.412 | 12.8 |
| G | 700 | 28 | 0.425 | 6.0 |

### Example 1

An all solid state battery was produced in the following manner using the sulfide solid electrolyte A in the cathode active material layer. The design capacity of the all solid state battery was 0.3 Ah.

A cathode active material (LiNi_{1/3}Co_{1/3}Mn_{1/3}O₂) 80.0 g, the sulfide solid electrolyte A 9.51 g, and a conductive aid (VGCF) 2.5 g were gathered in Filmix container. After that, a solution including styrene butadiene rubber that is a binder (the concentration of the binder in the solution to the whole solution was 5 mass %), and a solvent (tetralin) 32.21 g were added to the Filmix container. Thereby, a raw material composition for cathode of which solid concentration was 69 mass % was obtained. The raw material composition was kneaded using a kneading device (Filmix) to obtain an electrode composition for cathode. The electrode composition was applied on a surface of a cathode current collector (Al foil) in a film shape by a blade coating method using an applicator, and the electrode composition in a film shape was heated at 100° C. for 30 minutes. Thereby, a cathode including a cathode current collector and a cathode active material layer was obtained.

An anode active material (simple substance of Si) 18.6 g, a Li₂S—P₂S₅-based sulfide solid electrolyte 8.69 g, a solution including styrene butadiene rubber that is a binder (the concentration of the binder in the solution to the whole solution was 5 mass %) and a solvent (diisobutyl ketone) were added to a Filmix container. Thereby, a raw material composition for anode of which solid concentration was 43 mass % was obtained. The raw material composition was kneaded by a kneading device (Filmix) to obtain an electrode composition for anode. A PC wheel for high sharing was used for the Filmix. The electrode composition was applied on a surface of an anode current collector (nickel foil) in a film shape by a blade coating method using an applicator, and the electrode composition in a film shape was heated at 100° C. for 30 minutes. Thereby, an anode including an anode current collector and an anode active material layer was obtained.

A Li₂S—P₂S₅-based sulfide solid electrolyte 40 g, a solution including acrylate butadiene rubber and hexane (the concentration of acrylate butadiene rubber in the solution to the whole solution was 5 mass %) 8.00 g, heptane 25.62 g, and dibutyl ether 8.00 g were mixed, and kneaded by an ultrasonic homogenizer. Thereby, a solid electrolyte layer composition was obtained. The solid electrolyte layer composition was applied on a surface of an aluminum foil in a film shape by a blade coating method using an applicator, and the solid electrolyte layer composition in a film shape was heated at 100° C. for 30 minutes. Thereby, a transferring member including a substrate (aluminum foil) and the solid electrolyte layer was obtained.

The anode and the transferring member were overlapped so that the anode active material layer and the solid electrolyte layer faced to each other, and pressed at 20 kN. After that, the aluminum foil was peeled off, and the solid electrolyte layer was transferred onto the anode active material layer. Then, the cathode was overlapped so that the solid electrolyte layer and the cathode active material layer faced to each other, and pressed at 20 kN. Thereby, a layered body including layers in the order of the anode, the solid electrolyte layer, and the cathode, was obtained. This layered body was densified in the conditions of 25° C. and 2.5 ton/cm, and sealed by laminate to produce an all solid state battery. The produced battery was restrained at 5 MPa using a restraining jig.

### Examples 2 to 5 and Comparative Examples 1, 2

An all solid state battery was respectively produced in the same manner as in Example 1 except that the sulfide solid electrolyte A used in the cathode active material layer was changed to the sulfide solid electrolytes B to G as shown in Table 2.

### Example 6

An all solid state battery was produced in the same manner as in Example 1 except that the densifying conditions were changed to 100° C. and 2.5 ton/cm.

### Examples 7 to 10 and Comparative Examples 3, 4

An all solid state battery was respectively produced in the same manner as in Example 6 except that the sulfide solid electrolyte A used in the cathode active material layer was changed to the sulfide solid electrolytes B to G as shown in Table 2.

### Reference Example 1

An all solid state battery was produced in the same manner as in Example 1 except that the densifying conditions were changed to 135° C. and 2.5 ton/cm.

### Reference Examples 2 to 7

An all solid state battery was respectively produced in the same manner as in Reference Example 1, except that the sulfide solid electrolyte A used in the cathode active material layer was changed to sulfide solid electrolytes B to G as shown in Table 3.

### Reference Example 8

An all solid state battery was produced in the same manner as in Example 1 except that the densifying conditions were changed to 170° C. and 2.5 ton/cm.

### Reference Examples 9 to 14

An all solid state battery was respectively produced in the same manner as in Reference Example 8, except that the sulfide solid electrolyte A used in the cathode active material layer was changed to sulfide solid electrolytes B to G as shown in Table 3.

### [Evaluation]

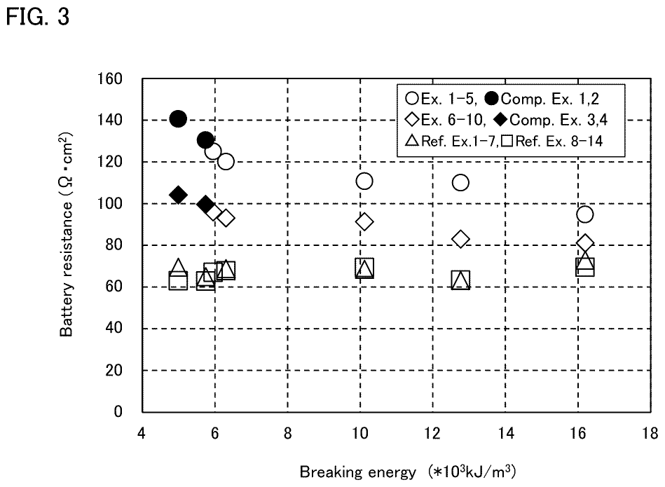

A charge and discharge test was conducted for each of the obtained all solid state batteries. The conditions for the charge and discharge test were CCCV charge and discharge of upper limit voltage 4.05 V and lower limit voltage 2.5 V, 0.1 C, and 4 cycles. The battery resistance after 4 cycles was measured. The results are shown in Table 2 and Table 3. Also, the relation between the breaking energy and the battery resistance is shown in FIG. 3.

TABLE 2

| | | | | Breaking | Battery |
|---|---|---|---|---|---|
| | | Densifying conditions | | energy | resis- |
| | SE | Temp. | Pressure | (*10³kJ/ | tance |
| | Kind | (° C.) | (ton/cm) | m³) | (Ω · cm²) |
| Example 1 | A | 25 | 2.5 | 16.2 | 95 |
| Example 2 | B | | | 10.1 | 111 |
| Example 3 | C | | | 6.3 | 120 |
| Comp. Ex. 1 | D | | | 5.7 | 130 |
| Comp. Ex. 2 | E | | | 5.0 | 141 |
| Example 4 | F | | | 12.8 | 110 |
| Example 5 | G | | | 6.0 | 125 |
| Example 6 | A | 100 | 2.5 | 16.2 | 81 |
| Example 7 | B | | | 10.1 | 91 |
| Example 8 | C | | | 6.3 | 93 |
| Comp. Ex. 3 | D | | | 5.7 | 100 |
| Comp. Ex. 4 | E | | | 5.0 | 104 |
| Example 9 | F | | | 12.8 | 83 |
| Example 10 | G | | | 6.0 | 96 |

TABLE 3

| | | | | Breaking | Battery |
|---|---|---|---|---|---|
| | | Densifying conditions | | energy | resis- |
| | SE | Temp. | Pressure | (*10³kJ/ | tance |
| | Kind | (° C.) | (ton/cm) | m³) | (Ω · cm²) |
| Ref. Ex. 1 | A | 135 | 2.5 | 16.2 | 73 |
| Ref. Ex. 2 | B | | | 10.1 | 68 |
| Ref. Ex. 3 | C | | | 6.3 | 69 |
| Ref. Ex. 4 | D | | | 5.7 | 65 |
| Ref. Ex. 5 | E | | | 5.0 | 69 |
| Ref. Ex. 6 | F | | | 12.8 | 63 |
| Ref. Ex. 7 | G | | | 6.0 | 69 |
| Ref. Ex. 8 | A | 170 | 2.5 | 16.2 | 69 |
| Ref. Ex. 9 | B | | | 10.1 | 69 |
| Ref. Ex. 10 | C | | | 6.3 | 68 |
| Ref. Ex. 11 | D | | | 5.7 | 63 |
| Ref. Ex. 12 | E | | | 5.0 | 63 |
| Ref. Ex. 13 | F | | | 12.8 | 63 |
| Ref. Ex. 14 | G | | | 6.0 | 67 |

As shown in Table 2 and FIG. 3, the battery resistance of Examples 1 to 5 was respectively lower than that of Comparative Examples 1 and 2. Also, in Examples 1 to 5, the larger the breaking energy of the sulfide solid electrolyte, the more the close adhesion (bonding force) of the sulfide solid electrolyte improved, generation of cracks in the cathode active material layer was inhibited, and the battery resistance decreased. Similarly, as shown in Table 3 and FIG. 3, the battery resistance of Examples 6 to 10 was respectively lower than that of Comparative Examples 3 and 4. Also, in Examples 6 to 10, the larger the breaking energy of the sulfide solid electrolyte, the more the close adhesion (bonding force) of the sulfide solid electrolyte improved, generation of cracks in the cathode active material layer was inhibited, and the battery resistance decreased.

Meanwhile, in Reference Examples 1 to 14, about the same battery resistance was obtained regardless of the breaking energy of the sulfide solid electrolyte. In contrast, in Examples 1 to 5 and Examples 6 to 10, compared to Reference Examples 1 to 14, the reduction of the battery resistance was achieved even though the temperature at the time of densification was low.

### <Production of Sulfide Solid Electrolytes H to K>

Sulfide solid electrolytes H to K were respectively produced in the same manner as for the sulfide solid electrolyte A, except that the burning temperature in the muffle furnace was changed as shown in Table 4. The breaking energy of the produced sulfide solid electrolytes H to K was respectively measured in the same manner as above. The results are shown in Table 4.

### Reference Example 15

An all solid state battery was produced in the following manner using the sulfide solid electrolyte H in the anode active material layer. The design capacity of the all solid state battery was 0.3 Ah.

An anode active material (simple substance of Si) 18.6 g, the sulfide solid electrolyte H 8.69 g, a solution including styrene butadiene rubber that is a binder (the concentration of the binder in the solution to the whole solution was 5 mass %) and a solvent (diisobutyl ketone) were added to a Filmix container. Thereby, a raw material composition for anode of which solid concentration was 43 mass % was obtained. The raw material composition was kneaded by a kneading device (Filmix) to obtain an electrode composition for anode. A PC wheel for high sharing was used for the Filmix. The electrode composition was applied on a surface of an anode current collector (nickel foil) in a film shape by a blade coating method using an applicator, and the electrode composition in a film shape was heated at 100° C. for 30 minutes. Thereby, an anode including an anode current collector and an anode active material layer was obtained.

A cathode active material (LiNi_{1/3}Co_{1/3}Mn_{1/3}O₂) 80.0 g, a Li₂S—P₂S₅-based sulfide solid electrolyte 9.51 g, and a conductive aid (VGCF) 2.5 g were gathered in Filmix container. After that, a solution including styrene butadiene rubber that is a binder (the concentration of the binder in the solution to the whole solution was 5 mass %), and a solvent (tetralin) 32.21 g were added to the Filmix container. Thereby, a raw material composition for cathode of which solid concentration was 69 mass % was obtained. The raw material composition was kneaded using a kneading device (Filmix) to obtain an electrode composition for cathode. The electrode composition was applied on a surface of a cathode current collector (aluminum foil) in a film shape by a blade coating method using an applicator, and the electrode composition in a film shape was heated at 100° C. for 30 minutes. Thereby, a cathode including a cathode current collector and a cathode active material layer was obtained.

A Li₂S—P₂S₅-based sulfide solid electrolyte 40 g, a solution including acrylate butadiene rubber and hexane (the concentration of acrylate butadiene rubber in the solution to the whole solution was 5 mass %) 8.00 g, heptane 25.62 g, and dibutyl ether 8.00 g were mixed, and kneaded by an ultrasonic homogenizer. Thereby, a solid electrolyte layer composition was obtained. The solid electrolyte layer composition was applied on a surface of an aluminum foil in a film shape by a blade coating method using an applicator, and the solid electrolyte layer composition in a film shape was heated at 100° C. for 30 minutes. Thereby, a transferring member including a substrate (aluminum foil) and the solid electrolyte layer was obtained.

The anode and the transferring member were overlapped so that the anode active material layer and the solid electrolyte layer faced to each other, and pressed at 20 kN. After that, the aluminum foil was peeled off, and the solid electrolyte layer was transferred onto the anode active material layer. Then, the cathode was overlapped so that the solid electrolyte layer and the cathode active material layer faced to each other, and pressed at 20 kN. Thereby, a layered body including layers in the order of the anode, the solid electrolyte layer, and the cathode, was obtained. This layered body was densified in the conditions of 170° C. and 4 ton/cm, and sealed by laminate to produce an all solid state battery. The produced battery was restrained at 5 MPa using a restraining jig.

### Reference Examples 16 to 18

An all solid state battery was respectively produced in the same manner as in Reference Example 15, except that the sulfide solid electrolyte H used in the anode active material layer was charged to sulfide solid electrolyte I to K as shown in Table 4.

### [Evaluation]

A charge and discharge test was conducted for each of the all solid state batteries obtained. The conditions for the charge and discharge test were CCCV charge and discharge of upper limit voltage 4.55 V, lower limit voltage 2.5 V, at 0.1 C, and 1000 cycles. The battery resistance after 1000 cycles was respectively measured. The results are shown in Table 4.

TABLE 4

| | SE | | | | Breaking | Battery |
|---|---|---|---|---|---|---|
| | | Burning | Densifying condition | | energy | resis- |
| | | Temp. | Temp. | Pressure | (*10³ kJ/ | tance |
| | Kind | (° C.) | (° C.) | (ton/cm) | m³) | (Ω · cm²) |
| Ref. | H | 160 | 170 | 4.0 | 67.9 | 102 |
| Ex. 15 | | | | | | |
| Ref. | I | 170 | | | 51.3 | 103 |
| Ex. 16 | | | | | | |
| Ref. | J | 180 | | | 51.7 | 100 |
| Ex. 17 | | | | | | |
| Ref. | K | 200 | | | 34.2 | 101 |
| Ex. 18 | | | | | | |

As shown in Reference Examples 15 to 18, the battery resistance was maintained low even when charge and discharge of 1000 cycles were performed to batteries using Si, of which volume change due to charge and discharge is large, was used as the anode active material.

### REFERENCE SIGNS LIST

1 cathode active material layer
2 anode active material layer
3 electrolyte layer
4 cathode current collector
5 anode current collector
10 battery

What is claimed is:

1. A solid electrolyte, of which breaking energy when formed into a pellet having a length in X axis direction of 5 mm, a length in Y axis direction of 20 mm, and a length in Z axis direction of 1 mm, at a filling rate of 100% is 6.0*10³ kJ/m³ or more and 21.4*10³ kJ/m³ or less.

2. The solid electrolyte according to claim 1, wherein the solid electrolyte is a sulfide solid electrolyte.

3. The solid electrolyte according to claim 2, wherein the sulfide solid electrolyte contains a Li element, an A element, which is at least one kind of P, As, Sb, Si, Ge, Sn, B, Al, Ga and In, and a S element.

4. The solid electrolyte according to claim 2, wherein the sulfide solid electrolyte contains a Li element, a P element, and a S element.

5. The solid electrolyte according to claim 4, wherein the sulfide solid electrolyte contains a halogen element.

6. An electrode mixture comprising an electrode active material and a solid electrolyte, wherein
the solid electrolyte is the solid electrolyte according to claim 1.

7. A battery comprising a cathode active material layer, an anode active material layer, and an electrolyte layer arranged between the cathode active material layer and the anode active material layer, wherein
at least one of the cathode active material layer and the anode active material layer contains the electrode mixture according to claim 6.
